(19) United States
(12) Patent Application Publication
(10) Pub. No.: US 2013/0276617 A1
(43) Pub. Date: Oct. 24, 2013

(54) Reversed Cajon Paddle

(71) Applicant: Nathan Gunter, Sacramento, CA (US)

(72) Inventor: Nathan Gunter, Sacramento, CA (US)

(21) Appl. No.: 13/453,899

(22) Filed: Apr. 23, 2012

(51) Int. Cl. G10D 13/02

(52) U.S. Cl. 84/422.1

(57) ABSTRACT

A reverse Cajon pedal to strike a Cajon musical device may include a foot plate which may be pivotably connected to a base plate and a link extension arm to move longitudinally in response to the foot plate. The link extension arm may rotate a beater to strike the Cajon musical device. The Cajon pedal may include a first clamp to hold the Cajon. The Cajon pedal may include a frame post to support the beater. The Cajon pedal may include a second clamp to slidably clamp to a base plate. The foot pedal may be connected to a first shaft.

### FIELD OF THE INVENTION

The present invention relates to musical percussion instruments, and more particularly to a cajon.

### BACKGROUND

The musical percussion instrument known as the cajon is well established in prior art. Being utilized in many musical art forms and various ethnic cultures across the globe, its popularity among percussion musicians is becoming increasingly widespread.

The cajon is most commonly played by sitting astride the cuboid wooden structure and striking a playing surface or head, generally made from a thinner material of greater tympanic qualities, with open hands onto one surface of the instrument. The result being a sound wave that reverberates throughout the sound chamber of the cubic form and exits, most commonly, through a circular hole located on an opposing surface of the cube. Therefore, by percussions provided by a musician to the striking surface, a distinct tonal quality, which is unique to this particular style of instrument, is provided.

Various apparatus forms have been added over time to the basic cajon to modify the intonation of the instrument, such as may be found in the various wire or rod curtains that may afford a snare-drum effect, or other damping, baffles or reed apparatus of prior art, for a few examples. Other modifications have been made to the sound exit hole or mouth of the sound chamber, by way of inserted or integrated tubular forms, in an attempt to increase or focus the sound volume.

### SUMMARY

A reverse Cajun pedal to strike a Cajun musical device may include a foot plate which may be pivotably connected to a base plate and a link extension arm to move longitudinally in response to the foot plate.

The link extension arm may rotate a beater to strike the Cajun musical device.

The Cajun pedal may include a first clamp to hold the Cajun.

The Cajun pedal may include a frame post to support the beater.

The Cajun pedal may include a second clamp to slidably clamp to a base plate.

The foot pedal may be connected to a first shaft.

### BRIEF DESCRIPTION OF THE DRAWINGS

The invention may be understood by reference to the following description taken in conjunction with the accompanying drawings, in which, like reference numerals identify like elements, and in which:

FIG. 1 illustrates a top view of a Cajon pedal of the present invention;

FIG. 2 illustrates a side view of the Cajon pedal of the present invention;

FIG. 3 illustrates an end view of the Cajon pedal of the present invention;

FIG. 4 illustrates a side view of the Cajon pedal of the present invention.

### DETAILED DESCRIPTION

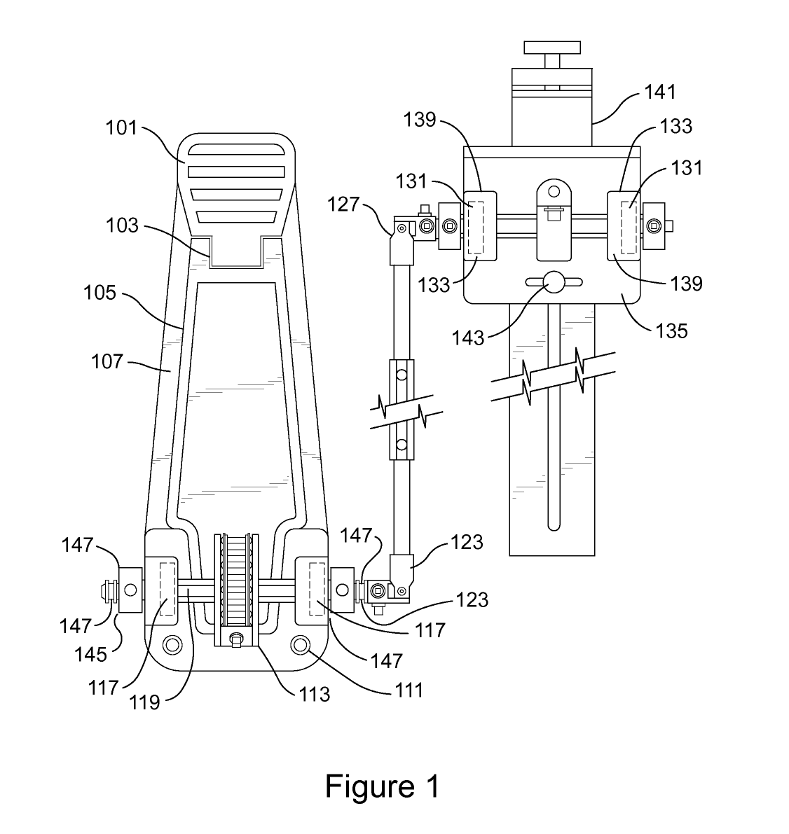

FIG. 1 illustrates a Cajon pedal 100 of the present invention which may include a heel plate 101 which may be mounted on a base plate 107, and the heel plate 101 may be pivotably connected to a foot board plate 107 by a heel plate hinge 103 to allow the foot board plate 107 to rotate by the user placing the heel of the user on the heel plate 101 and pressing on the foot board plate 107 with front section of the foot of the user. The distal end of the foot board plate 107 may be connected to a flexible connector 109 which may be a chain which may cooperate with a chain sprocket which may be connected to a chain cam 113 which may rotate on a first shaft 119 and which may rotate as the flexible connector 109 is extended in and out in response to the rotation of the floorboard plate 105. The first shaft 119 may cooperate with internal bearings 117 in order to rotate, and the internal bearings 117 may be mounted in a frame post 115 which may be connected to the base plate 107. A pair of opposing cams 121 may be mounted on the first shaft 119 and may be positioned adjacent to the frame post 115.

A biasing device 145 which may be a spring may connect between the spring wheel 147 and a portion 147 of the frame arms 115 which may extend outwards from the frame arm 115 to bias the shaft 119. The bias device 145 may include a bolt 149 to adjust the tension on the biasing device 145.

A single end of the first shaft 119 may be connected to a first universal swivel joint 123 which may be connected to a link extension arm 125 which may extend between the first universal swivel joint 123 and the second universal swivel joint 127. The link extension arm 125 may move substantially forwards and backwards in the longitudinal direction of the link extension arm 125, and the second universal swivel joint 127 may rotate the second shaft 129 which may be mounted on the internal bearings 131 which may be positioned within a frame post 133. A pair of opposing frame posts 133 may be mounted on a base 135 which may be slidably movable on a sliding plate 137. The second shaft 129 may be positioned between a pair of opposing cams 139.

A single end of the first shaft 119 may be connected to a first universal swivel joint 123 which may be connected to a link extension arm 125 which may extend between the first universal swivel joint 123 and the second universal swivel joint 127. The link extension arm 125 may move substantially forwards and backwards in the longitudinal direction of the link extension arm 125, and the second universal swivel joint 127 may rotate the second shaft 129 which may be mounted on the internal bearings 131 which may be positioned within a frame post 133. A pair of opposing frame posts 133 may be mounted on a base 135 which may be slidably movable on a sliding plate 137. The second shaft 129 may be positioned between a pair of opposing cams 139.

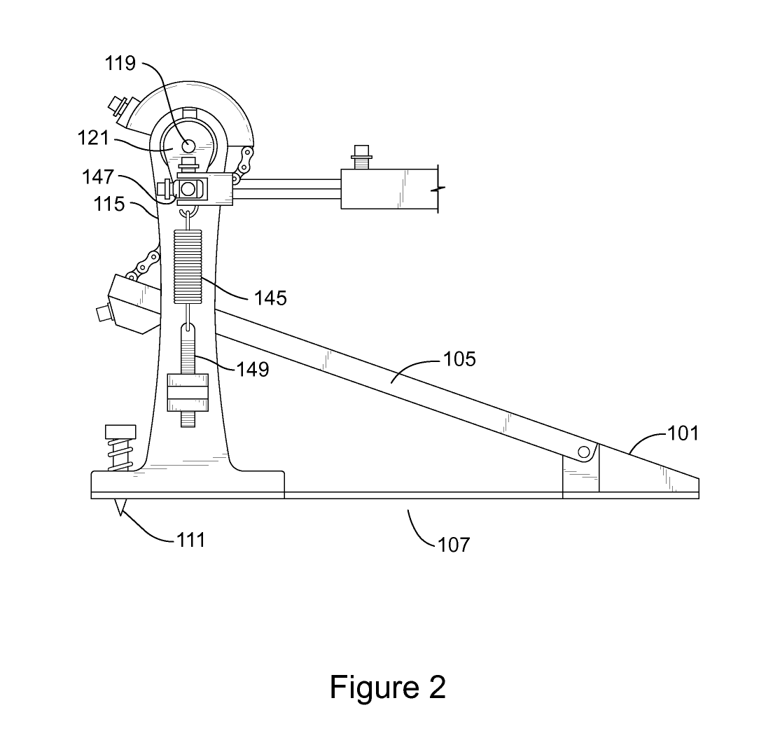

FIG. 2 illustrates a side view of the Cajon pedal 100 of the present invention which may include a heel plate 101 which may be mounted on a base plate 107, and the heel plate 101 may be pivotably connected to a foot board plate 107 by a heel plate hinge 103 to allow the foot board plate 107 to rotate by the user placing the heel of the user on the heel plate 101 and pressing on the foot board plate 107 with front section of the foot of the user. The distal end of the foot board plate 107 may be connected to a flexible connector 109 which may be a chain which may cooperate with a chain sprocket which may be connected to a chain cam 113 which may rotate on a first shaft 119 and which may rotate as the flexible connector 109 is extended in and out in response to the rotation of the floorboard plate 105. The first shaft 119 may cooperate with internal bearings 117 in order to rotate, and the internal bearings 117 may be mounted in a frame post 115 which may be connected to the base plate 107. A pair of opposing cams 121 may be mounted on the first shaft 119 and may be positioned adjacent to the frame post 115.

A biasing device 145 which may be a spring may connect between the spring wheel 147 and a portion 147 of the frame arms 115 which may extend outwards from the frame arm 115 to bias the shaft 119. The bias device 145 may include a bolt 149 to adjust the tension on the biasing device 145.

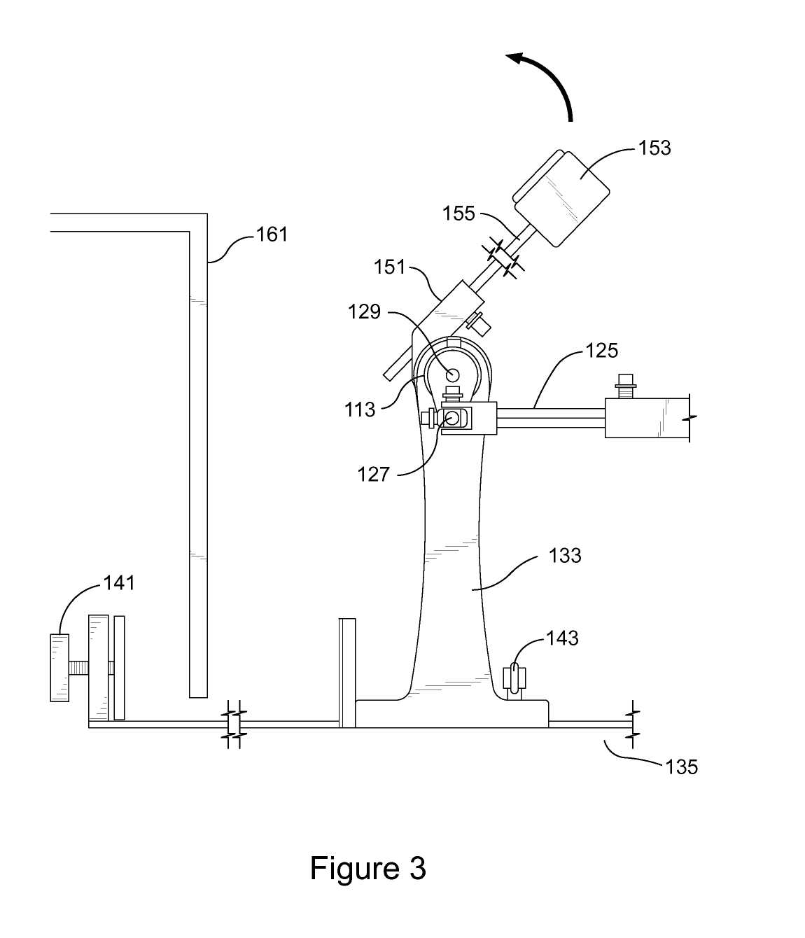

FIG. 3 illustrates a side view of the Cajon pedal 100 and illustrates a link extension arm 125 which may extend between the first universal swivel joint 123 and the second universal swivel joint 127. The link extension arm 125 may move substantially forwards and backwards in the longitudinal direction of the link extension arm 125, and the second universal swivel joint 127 may rotate the second shaft 129 which may be mounted on the internal bearings 131 which may be positioned within a frame post 133. A pair of opposing frame posts 133 may be mounted on a base 135 which may be slidably movable on a sliding plate 137. The second shaft 129 may be positioned between a pair of opposing cams 139.

A single end of the first shaft 119 may be connected to a first universal swivel joint 123 which may be connected to a link extension arm 125 which may extend between the first universal swivel joint 123 and the second universal swivel joint 127. The link extension arm 125 may move substantially forwards and backwards in the longitudinal direction of the link extension arm 125, and the second universal swivel joint 127 may rotate the second shaft 129 which may be mounted on the internal bearings 131 which may be positioned within a frame post 133. A pair of opposing frame posts 133 may be mounted on a base 135 which may be slidably movable on a sliding plate 137. The second shaft 129 may be positioned between a pair of opposing cams 139.

The second shaft 129 may be connected to a beater holder 151 which may be connected to a beater shaft 155 and which may be connected to a beater holder 151. As the second shaft 129 rotates in response to the user pressing on the foot board 105, the beater shaft 155 pivots as the second shaft 129 rotates and the beater 153 may strike the Cajon which may be positioned within the first clamp 141.

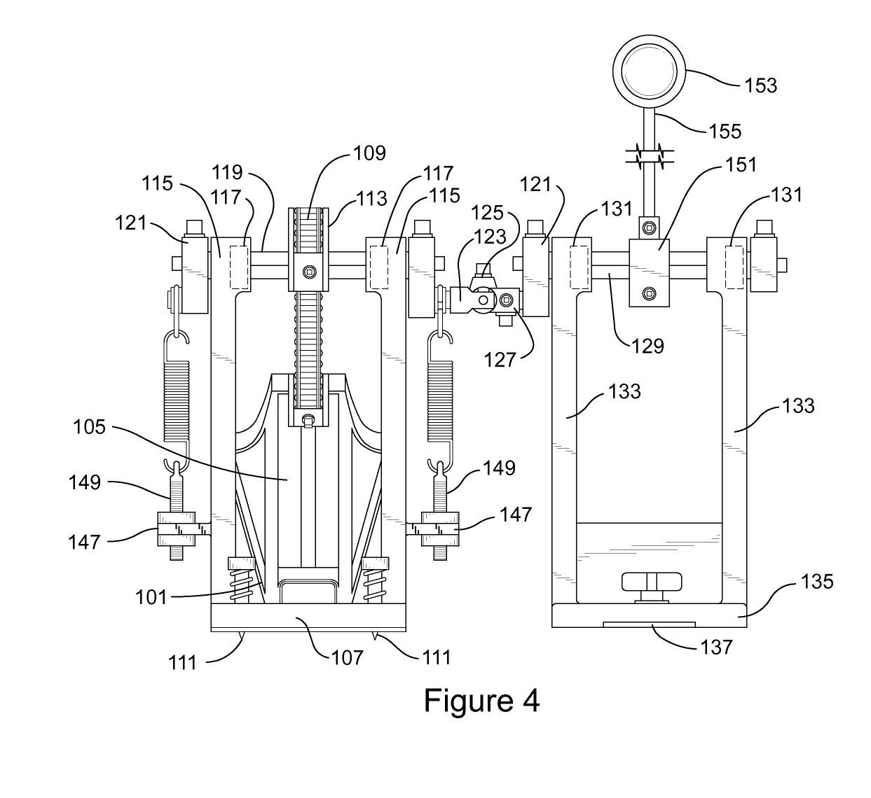

FIG. 4 illustrates a top view of a Cajon pedal 100 of the present invention which may include a heel plate 101 which may be mounted on a base plate 107, and the heel plate 101 may be pivotably connected to a foot board plate 107 by a heel plate hinge 103 to allow the foot board plate 107 to rotate by the user placing the heel of the user on the heel plate 101 and pressing on the foot board plate 107 with front section of the foot of the user. The distal end of the foot board plate 107 may be connected to a flexible connector 109 which may be a chain which may cooperate with a chain sprocket which may be connected to a chain cam 113 which may rotate on a first shaft 119 and which may rotate as the flexible connector 109 is extended in and out in response to the rotation of the floorboard plate 105. The first shaft 119 may cooperate with internal bearings 117 in order to rotate, and the internal bearings 117 may be mounted in a frame post 115 which may be connected to the base plate 107. A pair of opposing cams 121 may be mounted on the first shaft 119 and may be positioned adjacent to the frame post 115.

A biasing device 145 which may be a spring may connect between the spring wheel 147 and a portion 147 of the frame arms 115 which may extend outwards from the frame arm 115 to bias the shaft 119. The bias device 145 may include a bolt 149 to adjust the tension on the biasing device 145.

A single end of the first shaft 119 may be connected to a first universal swivel joint 123 which may be connected to a link extension arm 125 which may extend between the first universal swivel joint 123 and the second universal swivel joint 127. The link extension arm 125 may move substantially forwards and backwards in the longitudinal direction of the link extension arm 125, and the second universal swivel joint 127 may rotate the second shaft 129 which may be mounted on the internal bearings 131 which may be positioned within a frame post 133. A pair of opposing frame posts 133 may be mounted on a base 135 which may be slidably movable on a sliding plate 137. The second shaft 129 may be positioned between a pair of opposing cams 139.

A single end of the first shaft 119 may be connected to a first universal swivel joint 123 which may be connected to a link extension arm 125 which may extend between the first universal swivel joint 123 and the second universal swivel joint 127. The link extension arm 125 may move substantially forwards and backwards in the longitudinal direction of the link extension arm 125, and the second universal swivel joint 127 may rotate the second shaft 129 which may be mounted on the internal bearings 131 which may be positioned within a frame post 133. A pair of opposing frame posts 133 may be mounted on a base 135 which may be slidably movable on a sliding plate 137. The second shaft 129 may be positioned between a pair of opposing cams 139.

The second shaft 129 may be connected to a beater holder 151 which may be connected to a beater shaft 155 and which may be connected to a beater holder 151. As the second shaft 129 rotates in response to the user pressing on the foot board 105, the beater shaft 155 pivots as the second shaft 129 rotates and the beater 153 may strike the Cajon which may be positioned within the first clamp 141.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed.

1) A reverse Cajon pedal to strike a Cajon musical device, comprising:
a foot plate which may be pivotably connected to a base plate;
a link extension arm to move longitudinally in response to the foot plate;
the link extension arm rotating a beater to strike the Cajon musical device.

2) A reverse Cajon pedal to strike a Cajon musical device as in claim 1, wherein the Cajon pedal includes a first clamp to hold the ajon.

3) A reverse Cajon pedal to strike a Cajon musical device as in claim 1, wherein the Cajon pedal includes a frame post to support the beater.

4) A reverse Cajon pedal to strike a Cajon musical device as in claim 3, wherein the Cajon pedal includes a second clamp to slidably clamp to a base plate.

5) A reverse Cajon pedal to strike a Cajon musical device as in claim 1, wherein the foot pedal is connected to a first shaft.
